(19) United States
(12) Patent Application Publication
(10) Pub. No.: US 2025/0227785 A1
(43) Pub. Date: Jul. 10, 2025

(54) COMMUNICATION CONTROL METHOD, USER EQUIPMENT AND NETWORK NODE

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/091,271

(22) Filed: Mar. 26, 2025

Related U.S. Application Data
(63) Continuation of application No. PCT/JP2023/034424, filed on Sep. 22, 2023.
(60) Provisional application No. 63/409,868, filed on Sep. 26, 2022.

(51) Int. Cl. H04W 76/14; H04W 74/0833

(52) U.S. Cl. CPC H04W 76/14; H04W 74/0833

(57) ABSTRACT

In an aspect, a communication control method is a communication control method in a mobile communication system. The communication control method includes transmitting, by a user equipment, altitude information relating to an altitude of the user equipment to a network node either when establishing an RRC connection to the network node or after establishing the RRC connection to the network node.

### RELATED APPLICATIONS

The present application is a continuation based on PCT Application No. PCT/JP2023/034424, filed on Sep. 22, 2023, which claims the benefit of U.S. Provisional Patent Application No. 63/409,868 filed on Sep. 26, 2022. The content of which is incorporated by reference herein in their entirety.

### TECHNICAL FIELD

The present disclosure relates to a communication control method in a mobile communication system.

### BACKGROUND

In the specifications of the Third Generation Partnership Project (3GPP), which is a standardization project for mobile communication systems, an Aerial UE is defined (for example, see Non-Patent Document 1 and Non-Patent Document 2). For example, the Aerial UE can report an altitude or report position information including a vertical velocity and a horizontal velocity. In the 3GPP, communication with the Aerial UE flying in the sky is appropriately supported through such specifications.

### CITATION LIST

### Non-Patent Literature

Non-Patent Document 1: 3GPP TS 36.300 V17.1.0 (2022-6)

Non-Patent Document 2: 3GPP TS 36.331 V17.1.0 (2022-6)

### SUMMARY

In an aspect, a communication control method is a communication control method in a mobile communication system. The communication control method includes transmitting, by a user equipment, altitude information relating to an altitude of the user equipment to a network node either when establishing an RRC connection to the network node (or a network apparatus) or after establishing the RRC connection to the network node.

In an aspect, a communication control method is a communication control method in a mobile communication system. The communication control method includes the steps of: receiving, by a user equipment, sky cell information relating to a sky cell broadcast from a neighboring cell; and transmitting, by the user equipment, the sky cell information to a serving cell.

In an aspect, a communication control method is a communication control method in a mobile communication system. The communication control method includes either transmitting, by a network node, sky cell information relating to a sky cell to a neighboring network node or receiving, by the network node, the sky cell information from the neighboring network node.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a User Equipment (UE) according to the first embodiment.

FIG. 3 is a diagram illustrating a configuration example of a gNB (base station) according to the first embodiment.

FIG. 4 is a diagram illustrating a configuration example of a protocol stack of a user plane according to the first embodiment.

FIG. 5 is a diagram illustrating a configuration example of a protocol stack of a control plane according to the first embodiment.

FIG. 6 is a diagram illustrating a cell configuration example according to the first embodiment.

FIG. 7 is a diagram illustrating an operation example according to the first embodiment.

FIG. 8 is a diagram illustrating an operation example according to a second embodiment.

FIG. 9 is a diagram illustrating another operation example according to the second embodiment.

FIG. 10 is a diagram illustrating an operation example according to a third embodiment.

### DESCRIPTION OF EMBODIMENTS

A mobile communication system according to an embodiment will be described with reference to the drawings. In the description of the drawings, the same or similar parts are denoted by the same or similar reference signs.

### First Embodiment

### Configuration of Mobile Communication System

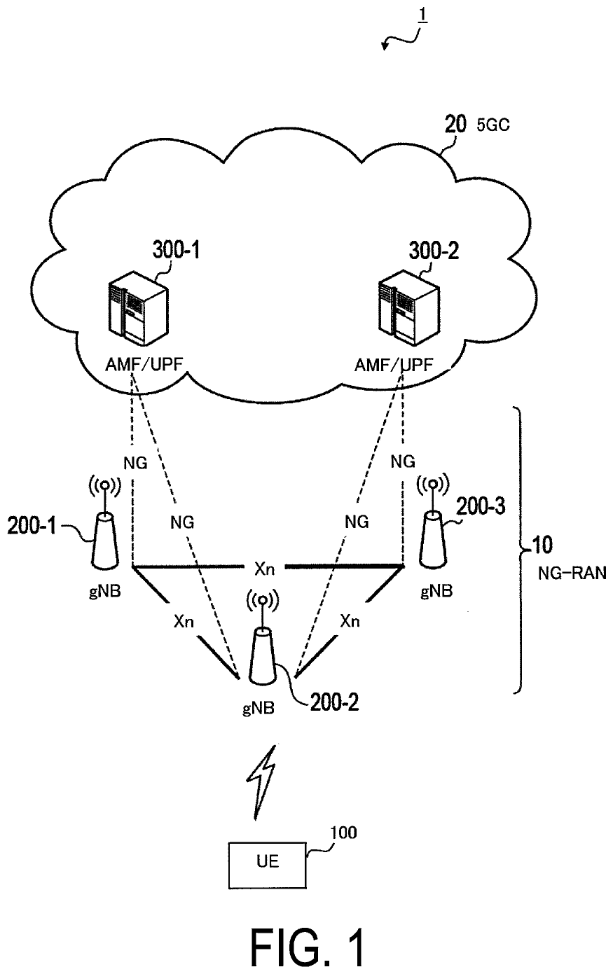

FIG. 1 is a diagram illustrating a configuration of a mobile communication system according to a first embodiment. A mobile communication system 1 complies with a 5th Generation System (5GS) of the 3GPP standards. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the Core Network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided to a sensor, a vehicle or an apparatus provided to a vehicle (Vehicle UE), and a flying object or an apparatus provided to a flying object (Aerial UE).

The NG-RAN 10 includes base stations (referred to as “gNBs” in the 5G system) 200. The gNBs 200 are interconnected via an Xn interface that is an inter-base station interface. Each gNB 200 manages one or more cells. The gNB 200 performs wireless communication with the UE 100 that has established connection to the cell of the gNB 200. The gNB 200 has a Radio Resource Management (RRM) function, a function of routing user data (hereinafter simply referred to as “data”), a measurement control function for mobility control and scheduling, and the like. “Cell” is used as a term representing a minimum unit of a wireless communication area. “Cell” is also used as a term representing a function or a resource for performing wireless communication with the UE 100. One cell belongs to one carrier frequency (hereinafter simply referred to as a “frequency”).

Note that the gNB 200 can also be connected to an Evolved Packet Core (EPC) that is an LTE core network. An LTE base station (evolved Node B (eNB)) can also be connected to the 5GC 20. The LTE base station and the gNB 200 can also be connected via an inter-base station interface.

The 5GC 20 includes an Access and Mobility Management Function (AMF) and a User Plane Function (UPF) 300. The AMF performs various types of mobility control and the like on the UE 100. The AMF manages mobility of the UE 100 by communicating with the UE 100 by using Non-Access Stratum (NAS) signaling. The UPF controls data transfer. The AMF and UPF are connected to the gNB 200 via an NG interface that is an interface between a base station and the core network.

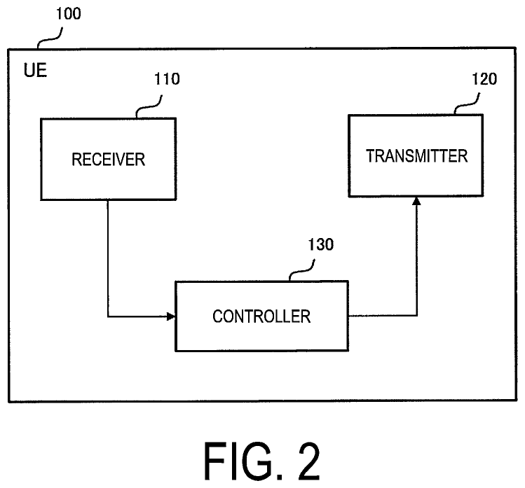

FIG. 2 is a diagram illustrating a configuration example of the user equipment 100 (UE) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (reception signal) and outputs the baseband signal to the controller 130.

The transmitter 120 performs various types of transmission under control of the controller 130. The transmitter 120 includes an antenna and a transmission device. The transmission device converts a baseband signal (transmission signal) output by the controller 130 into a radio signal and transmits the radio signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that the controller 130 may perform all processing or each operation in the UE 100 in each embodiment to be described below.

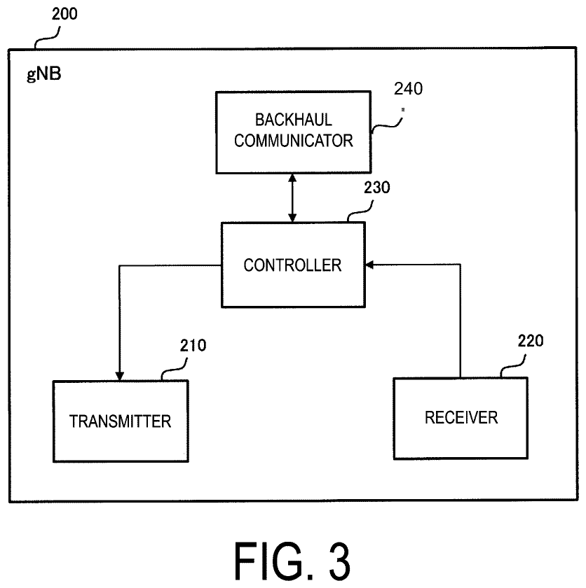

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (transmission signal) output by the controller 230 into a radio signal and transmits the radio signal through the antenna.

The receiver 220 performs various types of reception under control of the controller 230. The receiver 220 includes an antenna and a reception device. The reception device converts a radio signal received through the antenna into a baseband signal (reception signal) and outputs the baseband signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that the controller 230 may perform all processing or each operation in the gNB 200 in each embodiment to be described below.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

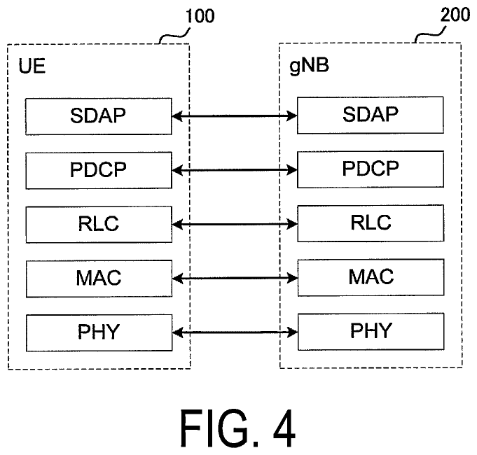

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). More specifically, the UE 100 blind decodes the PDCCH using a Radio Network Temporary Identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

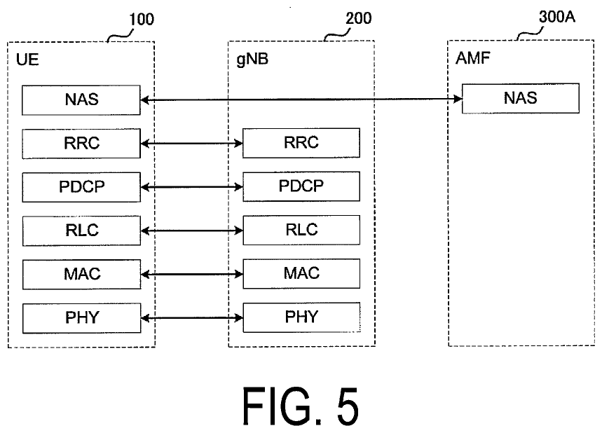

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS that is positioned upper than the RRC layer performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### UAV

An unmanned aerial vehicle (Unmanned Aerial Vehicle or Uncrewed Aerial Vehicle (UAV). An “unmanned aerial vehicle” may be referred to as a “UAV” below) according to the first embodiment will be described.

The UAV is generally an unmanned aircraft, such as a drone. However, in the first embodiment, a UE positioned at an altitude equal to or higher than a predetermined threshold value (or exceeding the predetermined threshold value) is referred to as a UAV. The UAV may be a UE capable of performing wireless communication with the gNB 200 while flying in the sky in an unmanned manner like an unmanned aircraft. The UAV may be provided to an unmanned aircraft. The UAV may be provided to a manned aircraft. For example, a UE owned by a user on board of an aircraft, while the aircraft is flying at an altitude equal to or higher than a predetermined threshold value, may also be a UAV. The UAV may be a UAV UE. The UAV may be an Aerial UE. The UAV may be distinguished from a UE that is used on the ground. However, when not particularly distinguished from the UE, the UAV may be included in a UE as an example of the UE. In this case, the UAV and the UE may collectively be referred to as the UE. The configuration example of the UE 100 illustrated in FIG. 2 may represent a configuration example of the UAV.

In the 3GPP, a function for supporting an Aerial UE is defined as follows, for example.

First, an Aerial UE can report its altitude. For example, the Aerial UE can report the altitude when its altitude becomes equal to or higher than or equal to or lower than a threshold value. At this time, the Aerial UE can also report position information. The position information may also include a horizontal velocity and a vertical velocity of the Aerial UE.

Second, a network (E-UTRAN) of the LTE system can request the Aerial UE to report flight path information. The flight path information represents a waypoint (passing point information or location point information) on a path of the Aerial UE. The flight path information may include a number of waypoints. The waypoint is represented as three-dimensional position information. The Aerial UE may report time information (time stamp) for each waypoint being included in the flight path information.

Third, whether an Aerial UE is supported (or whether the Aerial UE can be used as an Aerial UE) is included in subscription information for each user. The subscription information is stored for each user on a Home Subscriber Server (HSS) in the LTE system. Whether the Aerial UE is supported is included in the subscription information. The subscription information is transmitted from the HSS to an eNB that is a base station in the LTE system under control of a Mobility Management Entity (MME). The eNB can recognize whether to perform wireless communication with the Aerial UE.

Fourth, an event H1 and an event H2 can be used as a trigger condition for a measurement report. The event H1 represents an event condition when the altitude of the Aerial UE exceeds the threshold value. On the other hand, the event H2 represents an event condition when the altitude of the Aerial UE falls below the threshold value. These event conditions are each determined whether the condition is met by using a hysteresis value, an offset value, and a threshold value in addition to the altitude.

As described above, matters defined in the 3GPP are based on the assumption that the Aerial UE (i.e., the UAV) is used in the LTE system.

On the other hand, in the 3GPP, discussion on introduction of the UAV in NR (New Radio) has begun. With regard to the UAV, agreement has been made in the 3GPP. The agreement includes to use the above-mentioned event H1 and event H2, to report an altitude, a position, and a velocity of the UAV, to report a flight path plan, and the like.

### Terrestrial Cell and Sky Cell

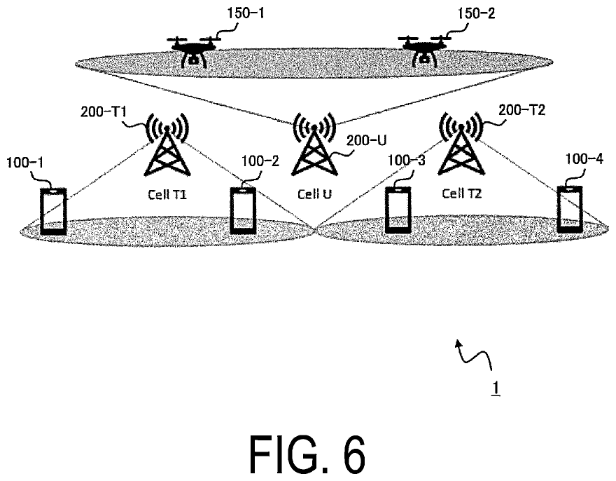

For example, it is assumed that a terrestrial cell and a sky cell coexist in a network. FIG. 6 is a diagram illustrating a cell configuration example of the case described above.

As illustrated in FIG. 6, a mobile communication system 1 includes terrestrial cells and a sky cell. In the example illustrated in FIG. 6, the terrestrial cells are constituted of a gNB 200-T1 and a gNB 200-T2, respectively, and the sky cell is constituted of a gNB 200-U. FIG. 6 illustrates an example in which UEs 100-1 to 100-4 each perform wireless communication with either the gNB 200-T1 or the 200-T2 in the terrestrial cell, and UAVs 150-1 and 150-2 each perform wireless communication with the gNB 200-U in the sky cell.

Here, in order for the UEs 100-1 to 100-4 to appropriately perform wireless communication in the terrestrial cells and in order for the UAVs 150-1 and 150-2 to appropriately perform wireless communication in the sky cell, the following two scenarios are assumed.

In the first scenario, a dedicated frequency is assigned to the sky cell, and different frequencies are used in the terrestrial cell and the sky cell. In the first scenario, for example, since wireless communication by the UAVs 150-1 and 150-2 and wireless communication by the UEs 100-1 to 100-4 is performed by using different frequencies, interference between the two wireless communications can be avoided.

On the other hand, in the second scenario, the same frequency (or the same frequency range) is used in the terrestrial cell and the sky cell. In the second scenario, since the frequency is shared by the terrestrial cell and the sky cell, frequency resources need not be specifically increased. Therefore, in the second scenario, effective use of frequency resources can be achieved.

### Communication Control Method According to First Embodiment

The first embodiment focuses on the second scenario. Problems that occur when applying the second scenario to the mobile communication system 1 include interference. For example, when the UAV 150-1 and the UAV 150-2 (hereinafter, may be referred to as a UAV 150 when the UAV 150-1 and the UAV 150-2 are not distinguished) perform uplink communication, there is a case that a radio signal reaches not only a serving cell and its neighboring cell but an even wider range. In such a case, when the UAV 150 and the UE 100 on the ground each use the same frequency, a signal from the UAV 150 may cause interference. There is a problem specific to the UAV that the influence of the interference is greater in wireless communication by the UAV 150 than in wireless communication by the UE 100 on the ground.

Therefore, in order to avoid interference in the second scenario, in the mobile communication system 1, it is necessary to quickly perform appropriate configuration for the UAV 150 flying in the sky.

However, in the mobile communication system 1, there is a problem of how to identify the UAV 150 flying in the sky in order to quickly perform appropriate configuration.

In the LTE system, an information element (Aerial UE subscription information), indicating whether the UE is permitted to function as an Aerial UE, can be transmitted from the HSS to the MME by using an S6a message. The information element can also be transmitted from the MME to the eNB by using a S1AP message. Thus, in the LTE system, the eNB can recognize whether the UE is allowed to function as an Aerial UE (or whether the UE has the capability of an Aerial UE).

However, the eNB cannot know so far whether the UE is actually flying. Therefore, there may be a case that the eNB cannot identify that the UE is a UAV. In NR, the 3GPP has currently not defined the gNB 200 to recognize whether the UE 100 is the UAV 150. Therefore, there may be a case that the gNB 200 cannot identify that the UE 100 is the UAV 150.

In the first embodiment, it is an object that the UE 100 can appropriately be identified as the UAV 150. To be specific, in the first embodiment, it is an object for the gNB 200 to be able to recognize whether the UE 100 is flying at an altitude higher than or equal to a certain level.

In the first embodiment, the user equipment (for example, the UE 100) transmits the altitude information relating to the altitude of the user equipment to the base station, either when establishing the RRC connection to the base station (for example, the gNB 200) or after establishing the RRC connection to the base station. As a result, when the gNB 200 recognizes that the UE 100 flies at an altitude exceeding the predetermined threshold value based on the altitude information of the UE 100, the gNB 200 can identify that the UE 100 flies in the sky, i.e., that the UE 100 is the UAV 150. By appropriately identifying that the UE 100 is the UAV 150, the gNB 200 can also quickly perform appropriate processing for the UAV 150, and can avoid the interference problem in the second scenario.

### Operation Example According to First Embodiment

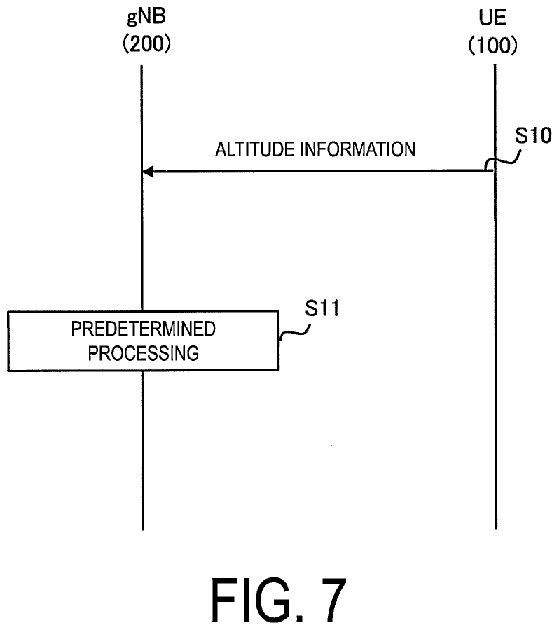

FIG. 7 is a diagram illustrating an operation example according to the first embodiment.

As illustrated in FIG. 7, in step S10, the UE 100 transmits the altitude information relating to its altitude to the gNB 200.

First, examples of the transmission method of the altitude information include the following. That is, the UE 100 in the RRC idle state or the RRC inactive state may transmit a message (Msg1) including the altitude information to the gNB 200 by using a random access resource dedicated to the UAV (dedicated to the unmanned aerial vehicle) (or a Physical Random Access Channel (PRACH) resource dedicated to the UAV). The random access resource dedicated to the UAV may be configured by the gNB 200 in advance. The UE may transmit a Msg3 (RRC Setup Request (RRCSetupRequest) message) including the altitude information instead of the Msg1. The UE may transmit a Msg5 (RRC Setup Complete (RRCSetupComplete) message) including the altitude information. The UE 100 in the RRC connected state may transmit UE-Assisted Information (UAI) including the altitude information to the gNB 200. In this way, the UE 100 may transmit the altitude information when establishing the RRC connection to the gNB 200. The UE 100 may transmit the altitude information after establishing the RRC connection. It is preferable that the UE 100 transmits the altitude information as soon as possible after establishing the RRC connection.

Second, examples of the information included in the altitude information include the following. That is, the altitude information may include information representing that the UE 100 has a flight capability. The altitude information may include information relating to the altitude of the UE 100 at present or in the past. The information relating to the altitude in the past may include time information (or a time stamp). The altitude information may include information representing the altitude of the UE 100 by using regions divided depending on the altitude (the information may be referred to as “region information”). The region information may include, for example, three pieces of region information, namely High altitude, Low altitude, and Terrestrial depending on the altitude. As described above, the altitude information may include the region information depending on the altitude of the UE 100 itself. The altitude information may be represented by the altitude acquired by an altitude sensor (or a distance sensor such as a radar or a lidar) provided to the UE 100. The altitude itself may be represented in sea level. The altitude itself may be represented in elevation. The altitude itself may be represented in height from the ground.

Third, the trigger for the UE 100 to transmit the altitude information is as follows, for example. That is, the UE 100 may transmit the altitude information when the current altitude is equal to or higher than a first threshold value (or when the current altitude becomes higher than the first threshold value). The first threshold value may be included in SIB and broadcast from the gNB 200.

In step S11, the gNB 200 performs predetermined processing in response to receiving the altitude information.

First, as the predetermined processing, the gNB 200 may perform a measurement configuration dedicated to the UAV for the UE 100 (i.e., the UAV 150). The measurement configuration dedicated to the UAV enables the UAV 150 to configure a trigger condition (for example, the H1 or the H2) for transmitting a measurement report or to configure information dedicated to the UAV (such as position information including altitude information) included in the measurement report. Note that the configuration may be performed when the gNB 200 transmits an RRC message (RRC Reconfiguration (RRCReconfiguration) message or RRC Resume (RRCResume) message) including the measurement configuration dedicated to the UAV to the UAV 150.

Second, as the predetermined processing, the gNB 200 may cause the UE 100 to be handed over to an appropriate frequency. For example, even in the second scenario, a frequency dedicated to the UAV and a frequency dedicated to the terrestrial UE may separately be used within a range of shared frequencies. When the gNB 200 determines that the UE 100 is the UAV 150, the gNB 200 may cause the UAV 150 to be handed over to a sky cell using a frequency dedicated to the UAV. To be specific, the UAV 150 may be configured with a measurement configuration in which the threshold value used in the event condition is made lower than a certain level so that the UAV 150 can easily be handed over to the cell.

### Second Embodiment

A second embodiment will be described. In the second embodiment, differences from the first embodiment will mainly be described.

The second embodiment is an example in which when the UE 100 in the RRC connected state with the serving cell 200-1 acquires the sky cell information relating to the sky cell from the neighboring cell (or neighboring gNB) 200-2, the UE 100 transmits the acquired sky cell information to the serving cell 200-1.

To be specific, first, the user equipment (for example, the UE 100) receives the sky cell information relating to the sky cell broadcast from the neighboring cell (for example, the neighboring cell 200-2). Second, the user equipment transmits the sky cell information to the serving cell (for example, the serving cell 200-1).

This makes it possible for the gNB 200-1 (or the serving cell) to recognize the sky cell information used in the neighboring gNB 200-2 (or the neighboring cell), for example. The gNB 200-1 can also perform interference avoidance processing for the UAV 150 based on the sky cell information. Thus, the gNB 200-1 can take measures to handle the interference problem in the second scenario.

### Operation Example According to Second Embodiment

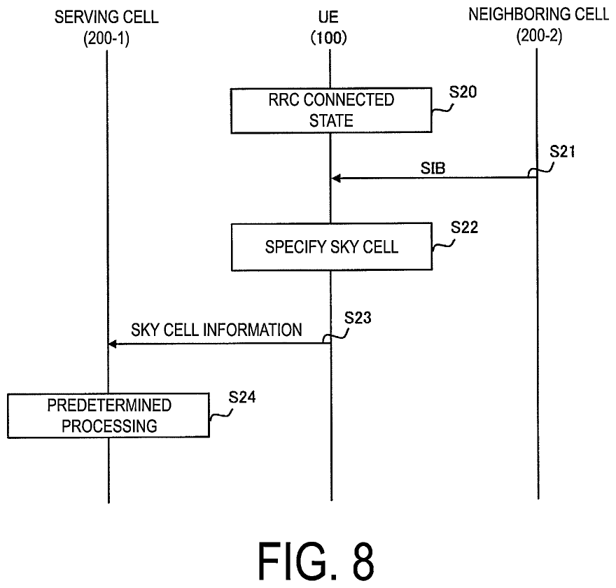

FIG. 8 is a diagram illustrating an operation example according to the second embodiment.

As illustrated in FIG. 8, in step S20, the UE 100 is in the RRC connected state with the serving cell 200-1 (or gNB 200-1).

In step S21, the neighboring cell (or the neighboring gNB) 200-2 neighboring the serving cell 200-1 broadcasts the system information block (SIB) including the sky cell information relating to the sky cell. In the sky cell information, a cell ID of the sky cell may be included. In the sky cell information, information on the frequency used in the sky cell (or sky frequency) may be included. In the sky cell information, the cell ID and/or the frequency may be represented in a list form. Note that the neighboring cell may broadcast cell list information representing the cell list managed by itself. In the cell list information, an identifier indicating to be a sky cell may be added to each entry of the cell list. The entry of the cell list, to which the identifier indicating to be a sky cell is added, may be the sky cell information. That is, the neighboring cell 200-2 may broadcast the cell list information including the sky cell information.

In step S22, the UE 100 specify the sky cell in response to receiving the SIB broadcast in step S21. For example, the UE 100 stores the cell ID of the sky cell in a memory or the like, and may specify the sky cell by comparing the cell ID with another cell ID included in the sky cell information received from the neighboring cell 200-2.

In step S23, the UE 100 transmits the sky cell information received from the neighboring cell 200-2 to the serving cell 200-1. The UE 100 may transmit the sky cell information to the serving cell 200-1 when its own altitude is higher than a second threshold value (or when its own altitude becomes equal to or higher than the second threshold value). This makes it possible for the serving cell 200-1 to identify that the UE 100 is the UAV 150 flying in the sky. The UE 100 may transmit the RRC message including the sky cell information to the serving cell 200-1. The second threshold value and the first threshold value (threshold value to determine whether to transmit the altitude information) described in the first embodiment may be the same threshold value or may be different threshold values. For example, the second threshold value may be broadcast from the serving cell 200-1 being included in the SIB.

In step S24, when the frequency used in the serving cell is different from the sky frequency included in the sky cell information received from the UE 100, the serving cell may perform predetermined processing. The predetermined processing includes the following three processes, for example.

First, the serving cell 200-1 performs transmission power control for the UE 100 as the predetermined processing. For example, when the serving cell 200-1 identifies that the UE 100 is the UAV 150, the serving cell 200-1 may perform a control such that the UAV 150 reduces transmission power by using a Transmission Power Control (TPC) command. This makes it possible to avoid interference caused by the radio signal transmitted from the UAV 150.

Second, as the predetermined processing, the serving cell 200-1 may cause the UE 100 to be handed over to an appropriate frequency as in the first embodiment. For example, when the serving cell 200-1 identifies that the UE 100 is the UAV 150, the serving cell 200-1 may perform a control such that the UAV 150 is handed over to a sky cell that supports a sky frequency.

Third, the serving cell 200-1 may release the UE 100 in the RRC connected state to the RRC idle state or the RRC inactive state as the predetermined processing. The serving cell 200-1 may release the UE 100 to the RRC idle state by transmitting an RRC Release (RRCRelease) message to the UE 100 in the RRC connected state. The serving cell 200-1 may release the UE 100 to the RRC inactive state by transmitting the RRC Release (RRCRelease) message including a suspension configuration (suspendconfig) to the UE 100 in the RRC connected state.

### Another Example of Second Embodiment

Another example of the second embodiment will be described.

In the second embodiment, an example has been described in which the sky cell information relating to the sky cell is transmitted from the neighboring cell 200-2 to the serving cell 200-1 via the UE 100, but the present invention is not limited thereto. For example, the gNB 200-1 and the neighboring gNB 200-2 can share the sky cell information by directly transmitting to each other, bypassing the UE 100.

To be specific, the base station (for example, gNB 200-1) either transmits the sky cell information relating to the sky cell to the neighboring base station (for example, neighboring gNB 200-2), or receives the sky cell information from the neighboring base station.

As a result, for example, the neighboring gNB 200-2 can know the sky cell information (for example, the cell ID used in the sky cell or the frequency of the sky cell) used in the gNB 200-1. The neighboring gNB 200-2 can prepare for the interference avoidance processing for the UAV 150 based on the sky cell information. Thus, the neighboring gNB 200-2 can take measures to handle the interference problem in the second scenario.

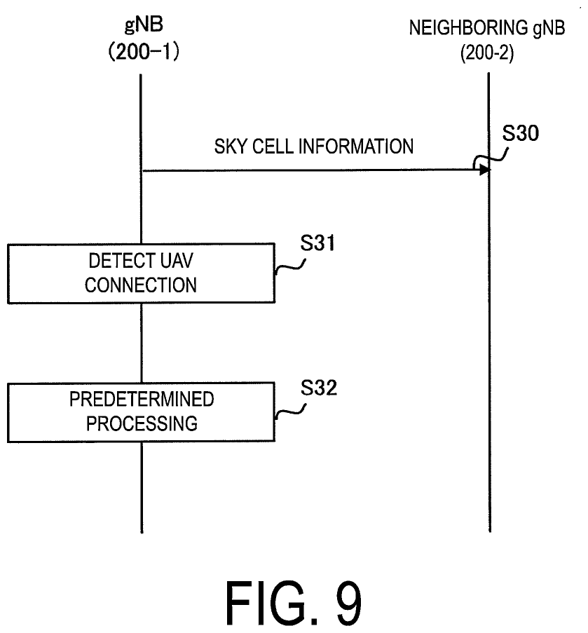

FIG. 9 is a diagram illustrating an operation example according to the second embodiment.

As illustrated in FIG. 9, in step S30, the gNB 200-1 transmits the sky cell information to the neighboring gNB 200-2 either when establishing the Xn connection to the neighboring gNB 200-2 or when changing the configuration for the neighboring gNB 200-2. The sky cell information may be the same as in the second embodiment. The gNB 200-1 may transmit the cell list information including the sky cell information. With regard to the transmission of the sky cell information, the gNB 200-1 may transmit an Xn connection Setup Request (XN SETUP REQUEST) message including the sky cell information to the neighboring gNB 200-2. The gNB 200-1 may transmit an NG-RAN node Configuration Update (NG-RAN NODE CONFIGURATION UPDATE) message including the sky cell information to the neighboring gNB 200-2.

In step S31, the gNB 200-1 detects the connection of the UAV 150. The UAV 150 transfers to the RRC connected state with the gNB 200-1.

In step S32, the gNB 200-1 may perform the predetermined processing. As in the second embodiment, the predetermined processing may be the transmission power control in a reducing direction for the UAV 150. As in the second embodiment, the predetermined processing may cause the UAV 150 to be handed over to the sky cell (or sky frequency). As in the second embodiment, the predetermined processing may release the UAV 150 in the RRC connected state to the RRC idle state or the RRC inactive state.

In another operation example of the second embodiment, the example in which the gNB 200-1 transmits the sky cell information to the neighboring gNB 200-2 has been described, but the present invention is not limited thereto. For example, the neighboring gNB 200-2 may transmit the sky cell information relating to the sky cell managed by itself to the gNB 200-1. Even when the gNB 200-1 transmits the sky cell information and even when the neighboring gNB 200-2 transmits the sky cell information, the sky cell information can be shared between the gNB 200-1 and the neighboring gNB 200-2.

### Third Embodiment

A third embodiment will be described.

In the third embodiment, an example will be described in which the UE 100 (i.e., the UAV 150) positioned at an altitude equal to or higher than the predetermined threshold value transmits a PRACH preamble by using a random access resource dedicated to the UAV (or a random access resource for the sky).

As described in the first embodiment, problems specific to the UAV include that the influence of interference is larger in the wireless communication by the UAV 150 than in the wireless communication by the UE 100 on the ground. In the discussion from now on in the 3GPP, it is assumed that various interference avoidance measures are taken for the UAV 150 in the RRC connected state.

On the other hand, when the random access procedure is performed by the UAV 150, in a case that interference occurs, there are currently no measures to avoid the interference.

Therefore, an object of the third embodiment is to avoid the interference in the random access procedure. To be specific, an object of the third embodiment is to avoid collision in PRACH preamble transmission.

In the third embodiment, first, a base station (for example, a gNB 200) configures a random access resource dedicated to the unmanned aerial vehicle (UAV) for a user equipment (for example, the UE 100). Second, the user equipment positioned at an altitude equal to or higher than the predetermined threshold value transmits the PRACH preamble to the base station by using the random access resource dedicated to the unmanned aerial vehicle (UAV).

As described above, in the third embodiment, since the UE 100 (or the UAV 150) transmits the PRACH preamble to the gNB 200 by using the random access resource dedicated to the UAV, collision with another PRACH preamble transmitted by using another resource can be avoided. Therefore, in the third embodiment, interference in the random access procedure can be avoided.

The main object of the third embodiment is to avoid interference and the main object of the first embodiment is to allow the gNB 200 to recognize whether the UE 100 is positioned at an altitude equal to or higher than the first threshold value. The two embodiments are different from each other with respect to their main object. However, also in the first embodiment, since the gNB 200, which has recognized that the UE 100 is the UAV 150, can configure the interference avoidance measure for the UAV 150, it can be said that the two embodiments share the object of interference avoidance.

Note that in the first embodiment, described is the transmission of the message (Msg1) including the altitude information by using the random access resource dedicated to the UAV. Such transmission can be performed by the configuration of the random access resource dedicated to the UAV done by the gNB 200.

Further, in Rel-17 of the 3GPP, a common framework for PRACH partitioning has been introduced. With the framework, a PRACH resource for each function such as Radio Reduced Capability (RedCap), Small Data Transmission (SDT), or RAN Slicing can be configured.

### Operation Example according to Third Embodiment

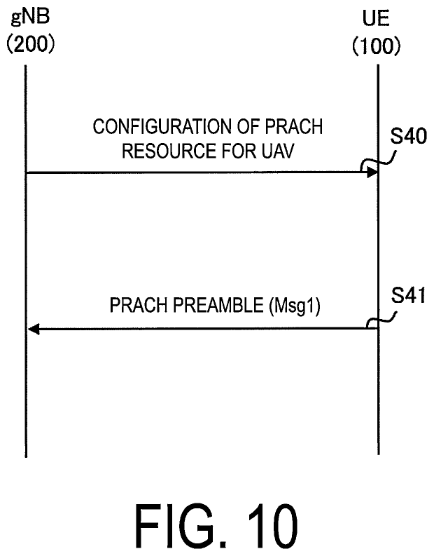

FIG. 10 is a diagram illustrating an operation example according to the third embodiment.

As illustrated in FIG. 10, in step S40, the gNB 200 configures the PRACH resource dedicated to the UAV for the UE 100.

First, the PRACH resource dedicated to the UAV may be configured. For example, the PRACH resource dedicated to the UAV may be added to the PRACH resource for the UE 100 on the ground. A new information element (for example, “Aerial vehicles”) representing to be dedicated to the UAV may be added to an information element (FeatureCombination) representing a function or a set of functions relating to the random access resource. The information on the PRACH resource dedicated to the UAV may be configured by an information element (RACH-ConfigCommon) representing the PRACH resource.

Second, the PRACH resource dedicated to the UAV may be configured for each altitude. For example, at an altitude in a first range, a PRACH resource #1 dedicated to the UAV is configured, at an altitude in a second range, a PRACH resource #2 dedicated to the UAV is configured, and the like. The information element (FeatureCombination) representing a function or a set of functions relating to the random access resource may include information elements (for example, “Aerial vehicles list”) indicated in a list format for each altitude. In the case above, the plurality of information elements (RACH-ConfigCommon) representing the PRACH resource may be configured for each altitude.

Note that the PRACH resource may be indicated by a RACH common configuration, a preamble number, and/or a radio resource number. The preamble number may be indicated as a range (for example, a start number and an end number) of the preamble numbers usable as the PRACH resource. The radio resource number may also be indicated as a range (for example, a start number and an end number) of the preamble numbers usable as the PRACH resource. The radio resource itself may be represented by a frequency and/or time.

In step S41, the UE 100 selects the PRACH resource depending on the altitude of itself and transmits the PRACH preamble by using the selected PRACH resource. When it is determined that the UE 100 is positioned at an altitude lower than the predetermined threshold value (or equal to or lower than the predetermined threshold value) (i.e., positioned on the ground), the UE 100 may transmit the PRACH preamble by using the normal PRACH resource that the UE 100 uses as the terrestrial UE. For example, when it is determined that the UE 100 is positioned at an altitude equal to or higher than the predetermined threshold value (or exceeding the predetermined threshold value), the UE 100 may transmit the PRACH preamble by using any PRACH resource dedicated to the UAV depending on the altitude.

Note that the predetermined threshold value may be the same as the first threshold value described in the first embodiment or may be the same as the second threshold value described in the second embodiment.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps need not be necessarily performed, and only some of the steps may be performed.

In the embodiments and the examples described above, an example in which the base station is an NR base station (i.e., a gNB) is described. However, the base station may be an LTE base station (i.e., an eNB) or a 6G base station. The base station may be a relay node such as an Integrated Access and Backhaul (IAB) node. The base station may be the DU of the IAB node. The UE 100 may be a Mobile Termination (MT) of the IAB node.

The term “network node” mainly refers to a base station, but may also refer to a core network apparatus or a part of a base station (the CU, the DU or an RU).

A program causing a computer to execute each of the processing performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. The terms “include” and “comprise” do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments has been described above in detail with reference to the drawings, but specific configurations are not limited to those described above, and various design variations can be made without departing from the gist of the present disclosure. All or some of the embodiments, operations, processes, and steps may be combined without being inconsistent.

### Supplementary Notes

### Supplementary Note 1

A communication control method in a mobile communication system, the communication control method including:
transmitting, by a user equipment, altitude information relating to an altitude of the user equipment to a network node either when establishing an RRC connection to the network node or after establishing the RRC connection to the network node.

### Supplementary Note 2

The communication control method according to Supplementary Note 1, wherein the transmitting includes transmitting, by the user equipment, a message including the altitude information to the network node by using a random access resource dedicated to an unmanned aerial vehicle (UAV).

### Supplementary Note 3

The communication control method according to any one of Supplementary Notes 1 or 2, wherein the altitude information includes information indicating that the user equipment has a flight capability.

### Supplementary Note 4

The communication control method according to any one of Supplementary Notes 1 to 3, wherein the altitude information includes information relating to the altitude of the user equipment at present or in the past.

### Supplementary Note 5

The communication control method according to any one of Supplementary Notes 1 to 4, wherein the altitude information includes information representing the altitude of the user equipment by using a region divided depending on the altitude.

### Supplementary Note 6

The communication control method according to any one of Supplementary Notes 1 to 5, wherein the transmitting includes transmitting, by the user equipment, the altitude information when the altitude of the user equipment is equal to or higher than a first threshold value.

### Supplementary Note 7

A communication control method in a mobile communication system, the communication control method including the steps of:
receiving, by a user equipment, sky cell information relating to a sky cell broadcast from a neighboring cell; and transmitting, by the user equipment, the sky cell information to a serving cell.

### Supplementary Note 8

The communication control method according to Supplementary Note 7, wherein the transmitting includes transmitting, by the user equipment, the sky cell information when an altitude of the user equipment is higher than a second threshold value.

### Supplementary Note 9

A communication control method in a mobile communication system, the communication control method including either transmitting, by a network node, sky cell information relating to a sky cell to a neighboring network node or receiving, by the network node, the sky cell information from the neighboring network node.

### Supplementary Note 10

The communication control method according to Supplementary Note 9, wherein the transmitting includes transmitting, by the network node, the sky cell information to the neighboring network node either when establishing a connection to the neighboring network node or when changing a configuration for the neighboring network node.

### Supplementary Note 11

The communication control method according to any one of Supplementary Notes 7 to 10, wherein the sky cell information includes a cell ID of the sky cell or a frequency used in the sky cell.

### Supplementary Note 12

A communication control method in a mobile communication system, the communication control method including the steps of:
configuring, by a network node, a random access resource dedicated to an unmanned aerial vehicle (UAV) for a user equipment; and
transmitting, by the user equipment positioned at an altitude equal to or higher than a predetermined threshold value, a PRACH preamble to the network node by using the random access resource dedicated to the unmanned aerial vehicle (UAV).

### Supplementary Note 13

The communication control method according to Supplementary Note 12, wherein the random access resource dedicated to the unmanned aerial vehicle (UAV) is a resource that differs depending on the altitude of the user equipment.

1. A communication control method in a mobile communication system, the communication control method comprising:
transmitting, by a user equipment, altitude information relating to an altitude of the user equipment to a network node either when establishing an RRC connection to the network node or after establishing the RRC connection to the network node.

2. The communication control method according to claim 1, wherein the transmitting comprises transmitting, by the user equipment, a message comprising the altitude information to the network node by using a random access resource dedicated to an unmanned aerial vehicle (UAV).

3. The communication control method according to claim 1, wherein the altitude information comprises information indicating that the user equipment has a flight capability.

4. The communication control method according to claim 1, wherein the altitude information comprises information relating to the altitude of the user equipment at present or in the past.

5. The communication control method according to claim 1, wherein the altitude information comprises information representing the altitude of the user equipment by using a region divided depending on the altitude.

6. The communication control method according to claim 1, wherein the transmitting comprises transmitting, by the user equipment, the altitude information when the altitude of the user equipment is equal to or higher than a first threshold value.

7. A communication control method in a mobile communication system, the communication control method comprising the steps of:
receiving, by a user equipment, sky cell information relating to a sky cell broadcast from a neighboring cell; and
transmitting, by the user equipment, the sky cell information to a serving cell.

8. The communication control method according to claim 7, wherein the transmitting comprises transmitting, by the user equipment, the sky cell information when an altitude of the user equipment is higher than a second threshold value.

9. A communication control method in a mobile communication system, the communication control method comprising:
either transmitting, by a network node, sky cell information relating to a sky cell to a neighboring network node or receiving, by the network node, the sky cell information from the neighboring network node.

10. The communication control method according to claim 9, wherein the transmitting comprises transmitting, by the network node, the sky cell information to the neighboring network node either when establishing a connection to the neighboring network node or when changing a configuration for the neighboring network node.

11. The communication control method according to claim 7, wherein the sky cell information comprises a cell ID of the sky cell or a frequency used in the sky cell.

12. A communication control method in a mobile communication system, the communication control method comprising the steps of:
configuring, by a network node, a random access resource dedicated to an unmanned aerial vehicle (UAV) for a user equipment; and
transmitting, by the user equipment positioned at an altitude equal to or higher than a predetermined threshold value, a PRACH preamble to the network node by using the random access resource dedicated to the unmanned aerial vehicle (UAV).

13. The communication control method according to claim 12, wherein the random access resource dedicated to the unmanned aerial vehicle (UAV) is a resource that differs depending on the altitude of the user equipment.

14. A user equipment in a mobile communication system, the user equipment comprising:
a transmitter configured to transmit altitude information relating to an altitude of the user equipment to a network node either when establishing an RRC connection to the network node or after establishing the RRC connection to the network node.

15. A network node in a mobile communication system, the network node comprising:
a transmitter configured to transmit sky cell information relating to a sky cell to a neighboring network node; and
a receiver configured to receive the sky cell information from the neighboring network node.
